(19) United States
(12) Patent Application Publication
(10) Pub. No.: US 2022/0400627 A1
(43) Pub. Date: Dec. 22, 2022

(54) INTELLIGENT CULTIVATING SYSTEM

(71) Applicants: Wan-Zhou YU, Yilan County (TW); Ting-Yu CHEN, Yilan County (TW); Hsuan-Chung HUANG, Yilan County (TW); Shun-Qing ZHANG, Yilan County (TW)

(72) Inventors: Wan-Zhou YU, Yilan County (TW); Ting-Yu CHEN, Yilan County (TW); Hsuan-Chung HUANG, Yilan County (TW); Shun-Qing ZHANG, Yilan County (TW)

(21) Appl. No.: 17/351,266

(22) Filed: Jun. 18, 2021

(51) Int. Cl. A01G 9/26; A01G 7/04; A01G 9/24; A01G 27/00; G05B 23/02; G05B 13/02

(52) U.S. Cl. CPC A01G 9/26; A01G 7/04; A01G 9/247; A01G 9/246; A01G 27/003; G05B 23/0216; G05B 13/0205

(57) ABSTRACT

The present invention provides an intelligent cultivating system, which is used for monitoring and identifying a current cultivating status of a cultivating creature, and includes a processing center, a remote monitoring system and a harvesting system. The processing center is used for providing a cultivating regulation and controlling process for monitoring and identifying a current cultivating status. The remote monitoring system is used for regulating and controlling an automatic cultivating parameter of the cultivating regulation and controlling process. The harvesting system is used for preparing a dispatching process to the cultivating creatures, and used for collecting the automatic cultivating parameter of the cultivating regulation and controlling process.

### BACKGROUND OF THE INVENTION

### 1. Field of the Invention

The present invention relates to a cultivating system, more particularly, the present invention provides an intelligent cultivating system.

### 2. Description of Related Art

In a conventional cultivating industry, the cultivating technologies are only known by the skilled cultivating operator, so that cultivating operator can rapidly make a plan corresponding to various external factors with his/her cultivating experiences according to a seasonal or a periodic cultivating condition.

However, when any unknown or an unexpected cultivating condition occurs, the situation may not be solved with respect to the existed experience, and only a means of try and error and hopping for good lucks can be made; as such, an affection in each cultivating step under an unexpected cultivating cannot be quantified, and the successful processing means may not be reused in future cultivating operation.

In view of the above-mentioned disadvantages, how to provide an intelligent cultivating system capable of increasing the successful rate of cultivating creature, the health of the cultivating creature and the harvesting amount of the cultivating creature without being affected by external affections such as manual factors or environmental factors, meanwhile reducing he labor cost and the possible lost caused by manual operations through the automatic cultivation for allowing the operator to pay more attentions to the creatures which are desired to be cultivated for increasing the successful rate of cultivating creature and recording the cultivating procedure with the high harvesting rate shall be seriously concerned by the skilled people in the art.

### SUMMARY OF THE INVENTION

For solving the shortages existed in the prior art, one primary objective of the present invention is to provide an intelligent cultivating system, which is used for monitoring and identifying a current cultivating status of a cultivating creature, and includes a processing center, a remote monitoring system and a harvesting system. The processing center is used for providing a cultivating regulation and controlling process for monitoring and identifying a current cultivating status. The remote monitoring system is used for regulating and controlling an automatic cultivating parameter of the cultivating regulation and controlling process so as to be sent to the processing center. The harvesting system is used for preparing a dispatching process to the cultivating creatures, and used for collecting the automatic cultivating parameter of the cultivating regulation and controlling process of the remote monitoring system.

For achieving the aforesaid objective, the processing center of the intelligent cultivating system of the present invention includes an automatic controlling module, a monitoring module and an identifying module. The automatic controlling module is used for processing an automatic operating mechanism to at least one cultivating regulation and control equipment, the monitoring module is used for monitoring the automatic cultivating parameter of the processing center, and the identifying module is used for identifying at least one characteristic of the cultivating creatures.

For achieving the aforesaid objective, actions controlled by the automatic controlling module of the intelligent cultivating system of the present invention include providing feeding food, providing water quality regulating agents, discharging dirts and changing water, adjusting temperature, adjusting oxygen content and adjusting voltage.

For achieving the aforesaid objective, monitoring means utilized in the monitoring module of the intelligent cultivating system of the present invention include a photoelectric colorimetric means, an electrode means and an image identifying means.

For achieving the aforesaid objective, identifying means utilized in the identifying module of the intelligent cultivating system of the present invention include a comparing means of harvestable model of cultivating creatures and an image identifying means.

For achieving the aforesaid objective, the remote monitoring system of the intelligent cultivating system of the present invention includes an interface module and a commanding module, the interfacing module is able to monitor a current cultivating status of the cultivating creatures through a plurality of operator monitoring programs and a plurality of operator monitoring platforms, and the commending module is able to send a controlling command to the automatic controlling module.

For achieving the aforesaid objective, the plurality of operator monitoring platforms of the intelligent cultivating system of the present invention include a browser, a computer and a portable device.

For achieving the aforesaid objective, the harvesting system of the intelligent cultivating system of the present invention includes an automatic harvesting module and a commercializing module, the automatic harvesting module is used for performing a harvesting process, a cleaning process and a storing process to the cultivating creatures, and the commercializing module enables the cultivating creatures to be readying for being dispatched through a size screening step, a packaging step and a finished product recording step.

For achieving the aforesaid objective, the harvesting system of the intelligent cultivating system of the present invention further includes a creature adopting module which provides at least one successful adopting parameter for allowing an external operator for processing an adopting evaluation.

For achieving the aforesaid objective, the at least one successful adopting parameter of the intelligent cultivating system of the present invention includes harvesting time, harvesting amount and bioavailabliity.

Accordingly, with the intelligent cultivating system of the present invention, the successful rate of cultivating creature, the health of the cultivating creature and the harvesting amount of the cultivating creature can be effectively increased without being affected by external affections such as manual factors or environmental factors. Moreover, the labor cost and the possible lost caused by manual operations can be reduced through the automatic cultivation, so that the operator can pay more attentions to the creatures which are desired to be cultivated, the successful rate of cultivating creature can be increased, and the cultivating procedure with the high harvesting rate can be recorded as the references of future cultivation.

### BRIEF DESCRIPTION OF THE DRAWINGS

FIG. 1 is a schematic view showing an intelligent cultivating system according to the present invention;

FIG. 2 is a schematic view showing modules included in the processing center of the intelligent cultivating system according to the present invention;

FIG. 3 is a schematic view showing modules included in the remote monitoring system of the intelligent cultivating system according to the present invention; and

FIG. 4 is a schematic view showing modules included in the harvesting module of the intelligent cultivating system according to the present invention.

### BRIEF DESCRIPTION OF THE CODES

100: Intelligent cultivating system
200: Processing center
210: Automatic controlling module
220: Monitoring module
230: Identifying module
300: Remote monitoring system
310: Interfacing module
320: Commanding module
400: Harvesting system
410: Automatic harvesting module
420: Commercializing module
430: Creature adopting module

### DETAILED DESCRIPTION OF THE PREFERRED EMBODIMENT

One preferred embodiment of the present invention will be described with reference to the drawings for illustrating the structural assembly, the technical means and the functions to be achieved by the present invention; and the actual ratios and the arrangement of components shall not be limited by the ratios and the arrangement of components in the provided figures.

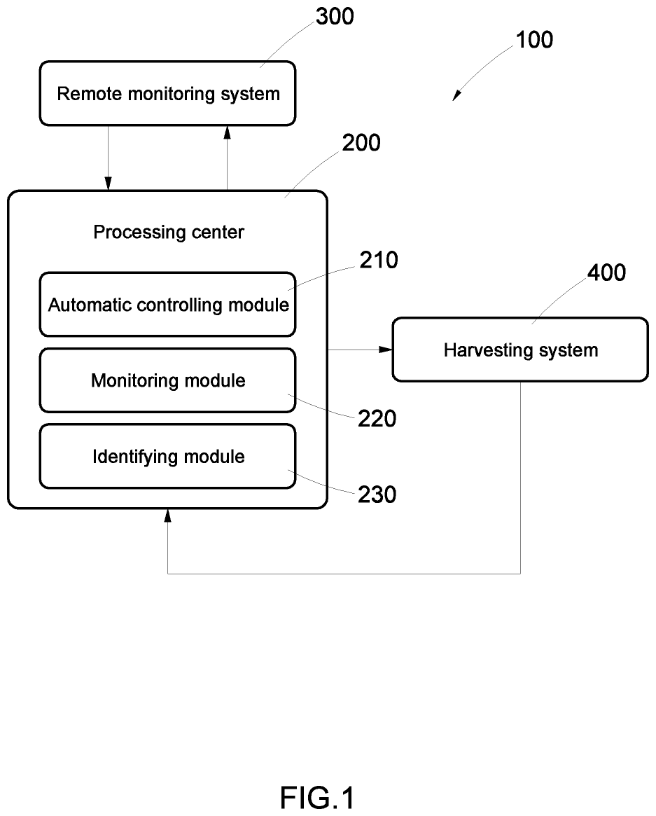

Please refer to FIG. 1, the present invention provides an intelligent cultivating system 100 which is used for monitoring and identifying a current cultivating status of cultivating creatures (for example prawns). According to the present invention, the intelligent cultivating system 100 includes a processing center 200, a remote monitoring system 300 and a harvesting system 400.

The processing center 200 is used for providing a cultivating regulation and controlling process for monitoring and identifying the current cultivating status. The remote monitoring system 300 is used for regulating and controlling an automatic cultivating parameter of the cultivating regulation and controlling process so as to be sent to the processing center 200. The harvesting system 400 is used for preparing a dispatching process to the cultivating creatures, and used for collecting the automatic cultivating parameter of the cultivating regulation and controlling process of the remote monitoring system 300.

What shall be addressed is as follows. According to this embodiment provided by the present invention, the intelligent cultivating system 100 can be provided with a pre-cultivating treatment, which is to preset a pro-project setting or a regular work setting before actually processing the operation of cultivating creatures. The pre-cultivating treatment includes, but not limits to, a cultivating farm design, a location selection or rental, an environment constructing establishment, a cultivating equipment installation, a monitoring equipment installation, a cultivating equipment test run, and a regular on-site observation. After the cultivating equipment is installed, the intelligent cultivating system 100 provided by the present invention is able to be operated.

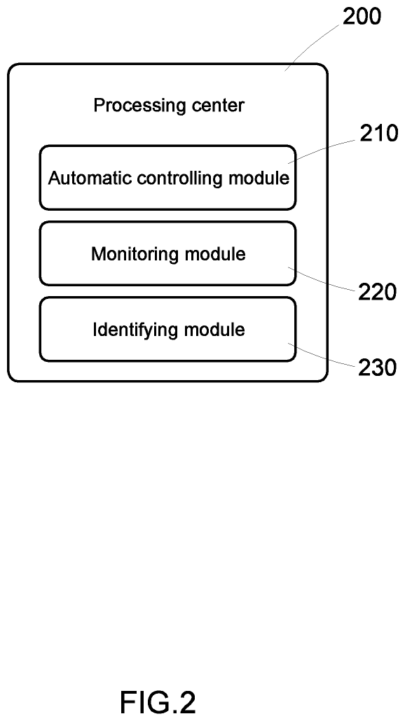

Please refer to FIG. 1 and FIG. 2, according to the intelligent cultivating system 100 of the present invention, the processing center 200 includes an automatic controlling module 210, a monitoring module 220 and an identifying module 230. The automatic controlling module 210 is used for processing an automatic operating mechanism to at least one cultivating regulation and control equipment, the monitoring module 220 is used for monitoring the automatic cultivating parameter of the processing center 200, and the identifying module 230 is used for identifying at least one characteristic of the cultivating creatures.

Wherein, actions controlled by the automatic controlling module 210 includes, but not limits to, providing feeding food, providing water quality regulating agents, discharging dirts and changing water, adjusting temperature, adjusting oxygen content and adjusting voltage, so that conventional manual operations can be directly achieved by the automatic controlling module 210, thereby providing a fully-automatic cultivating operation.

Monitoring means utilized in the monitoring module 220 includes a photoelectric colorimetric means, an electrode means, an image identifying means, and a cultivating parameter monitoring means, wherein the cultivating parameter includes, but not limits to nitrite, vibrio, ammonia, salinity, PH value, dissolved oxygen and temperature, and is served as operation references of the automatic controlling module 210. The equipment monitoring work includes, but not limits to, operating time, standby time, and equipment maintenance status, so that the system is able to automatically work with the cultivating monitoring data for regulating and controlling an equipment operating mode.

The identifying module 230 is used for collecting the technical data of the identifying characteristics of the cultivating creatures for allowing the system and an operator to remotely monitor. Identifying means utilized in the identifying module 230 includes a comparing means of harvestable model of cultivating creatures and an image identifying means, which is used for identifying cultivating creature characteristics including, but not limiting to, appearance, color, body size, active level and food eating condition, and is served as operation references of the automatic controlling module 210. Moreover, the processing center 200 includes, but not limits to, an artificial-intelligence or an automatic cultivating regulation and control means, so that the current cultivating status can be timely monitored and identified, thereby providing an optimal cultivating process and standardizing the cultivating procedure via recording relevant data.

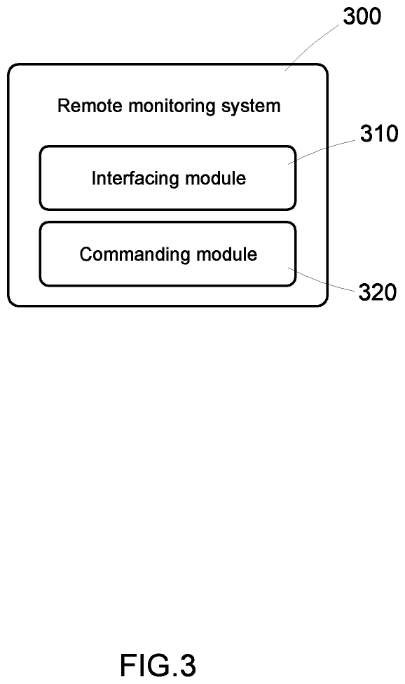

Please refer to FIG. 3, according to the intelligent cultivating system 100 provided by the present invention, the remote monitoring system 300 includes an interface module 310 and a commanding module 320. The interfacing module 310 is able to monitor the current cultivating status of the cultivating creatures through a plurality of operator monitoring programs and a plurality of operator monitoring platforms, and the commending module 320 is able to send a controlling command to the automatic controlling module 210.

Wherein, the interface module 310 allows the system to provide the monitoring programs suitably to be operated in a plurality of devices, so that the operator is able to know the current cultivating status through images, and when the operator wants to manually control the cultivating system, the command can be sent to the intelligent cultivating system 100 through the commanding module 320 for controlling the cultivation. The plurality of operator monitoring platforms provided to the intelligent cultivating system 100 includes a browser, a computer and a portable device (for example a mobile phone or a tablet computer), so that the command can be sent to the intelligent cultivating system 100 through the commanding module 320, and the relevant data can be displayed in the image for providing determining references and monitoring indications to the operator.

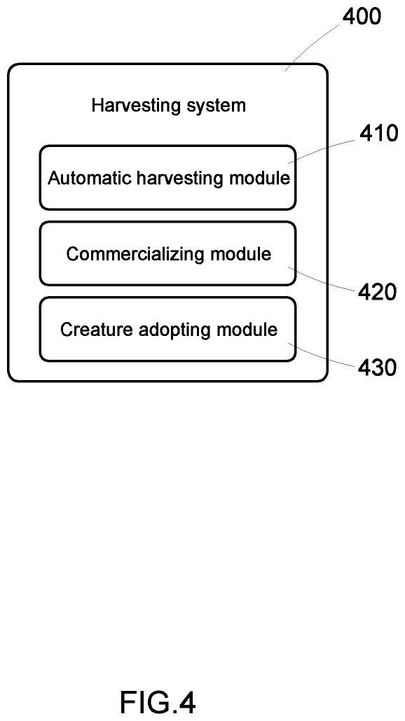

The commanding module 320 allows the operator to send a command through the interface module 310 for controlling the cultivating environment or the cultivating procedure, and the equipment operating mode, thereby achieving a requirement of the operator. The commanding module 320 are able to control necessary processes required for the cultivation, including, but not limiting to, providing feeding food, providing water quality regulating agents, discharging dirts and changing water, adjusting temperature, adjusting oxygen content, adjusting voltage and regulating equipment operating mode. Please refer to FIG. 4, according to the intelligent cultivating system 100 provided by the present invention, the harvesting system 400 includes an automatic harvesting module 410 and a commercializing module 420. The automatic harvesting module 410 is used for performing a harvesting process, a cleaning process and a storing process to the cultivating creatures, thereby finishing a harvesting treatment. The commercializing module 420 is used for commercializing the cultivating creatures harvested by the automatic harvesting module 410 for allowing the harvested cultivating creatures to be ready for being dispatched, and the commercializing module 420 enables the cultivating creatures to be readying for being dispatched through a size screening step, a packaging step and a finished product recording step.

As shown in FIG. 4, according to the intelligent cultivating system 100 provided by the present invention, the harvesting system 400 further includes a creature adopting module 430 which provides at least one successful adopting parameter for allowing an external operator for processing an adopting evaluation. Wherein, the at least one successful adopting parameter includes, but not limits to, harvesting time, harvesting amount, and bioavailabliity for allowing the external operator to process the adopting evaluation.

Based on what has been disclosed above, advantages achieved by the intelligent cultivating system 100 provided by the present invention are as follows. The successful rate of cultivating creature, the health of the cultivating creature and the harvesting amount of the cultivating creature can be effectively increased without being affected by external affections such as manual factors or environmental factors. Moreover, the labor cost and the possible lost caused by manual operations can be reduced through the automatic cultivation, so that the operator can pay more attentions to the creatures which are desired to be cultivated, the successful rate of cultivating creature can be increased, and the cultivating procedure with the high harvesting rate can be recorded as the references of future cultivation.

Moreover, with the installation of the identifying module 230 of the processing center 200, the growing status of the cultivating creatures can be confirmed without a process of physically grabbing the creature, so the possible damage to the cultivating creatures can be lowered, and with the installation of the remote monitoring system 300, the labors required for managing the cultivating farm and the labor cost can both be reduced.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A intelligent cultivating system, used for monitoring and identifying a current cultivating status of a cultivating creature, and includes:
a processing center, used for providing a cultivating regulation and controlling process for monitoring and identifying a current cultivating status;
a remote monitoring system, used for regulating and controlling an automatic cultivating parameter of the cultivating regulation and controlling process so as to be sent to the processing center; and
a harvesting system, used for preparing a dispatching process to the cultivating creatures, and used for collecting the automatic cultivating parameter of the cultivating regulation and controlling process of the remote monitoring system.

2. The intelligent cultivating system as claimed in claim 1, wherein the processing center includes an automatic controlling module, a monitoring module and an identifying module, the automatic controlling module is used for processing an automatic operating mechanism to at least one cultivating regulation and control equipment, the monitoring module is used for monitoring the automatic cultivating parameter of the processing center, and the identifying module is used for identifying at least one characteristic of the cultivating creatures.

3. The intelligent cultivating system as claimed in claim 2, wherein actions controlled by the automatic controlling module include providing feeding food, providing water quality regulating agents, discharging dirts and changing water, adjusting temperature, adjusting oxygen content and adjusting voltage.

4. The intelligent cultivating system as claimed in claim 2, wherein means utilized in the monitoring module include a photoelectric colorimetric means, an electrode means and an image identifying means.

5. The intelligent cultivating system as claimed in claim 2, wherein identifying means utilized in the identifying module include a comparing means of harvestable model of cultivating creatures and an image identifying means.

6. The intelligent cultivating system as claimed in claim 2, wherein the remote monitoring system includes an interfacing module and a commanding module, the interfacing module is able to monitor a current cultivating status of the cultivating creatures through a plurality of operator monitoring programs and a plurality of operator monitoring platforms, and the commending module is able to send a controlling command to the automatic controlling module.

7. The intelligent cultivating system as claimed in claim 6, wherein the plurality of operator monitoring platforms include a browser, a computer and a portable device.

8. The intelligent cultivating system as claimed in claim 1, wherein the harvesting system includes an automatic harvesting module and a commercializing module, the automatic harvesting module is used for performing a harvesting process, a cleaning process and a storing process to the cultivating creatures, and the commercializing module enables the cultivating creatures to be readying for being dispatched through a size screening step, a packaging step and a finished product recording step.

9. The intelligent cultivating system as claimed in claim 8, wherein the harvesting system further includes a creature adopting module which provides at least one successful adopting parameter for allowing an external operator for processing an adopting evaluation.

10. The intelligent cultivating system as claimed in claim 9, wherein the at least one successful adopting parameter includes harvesting time, harvesting amount and bioavailabliity.
